(19) United States
(12) Patent Application Publication
(10) Pub. No.: US 2003/0221919 A1
(43) Pub. Date: Dec. 4, 2003

(54) Disc brake

(75) Inventors: Futoshi Kumamoto, Anjo-shi (JP); Takeshi Naito, Fukuchiyama-shi (JP)

Correspondence Address: BURNS, DOANE, SWECKER & MATHIS, L.L.P., P.O. Box 1404, Alexandria, VA, 22313-1404, US

(73) Assignees: Advics Co., Ltd; Kokusan Parts Industry Co., Ltd.

(21) Appl. No.: 10/448,216

(22) Filed: May 30, 2003

(30) Foreign Application Priority Data
May 31, 2002 (JP) 2002-158773

(51) Int. Cl. F16D 65/38

(52) U.S. Cl. 188/73.37

(57) ABSTRACT

A disc brake includes a disc rotor, a pad having a backing plate, a press member for pressing the pad toward the disc rotor, and an anti-squeal layered shim attached to the backing plate and disposed between the press member and the backing plate of the pad. The layered shim includes a pad-side shim and a press-member-side shim. A depression is provided on a surface of the pad-side shim, the surface facing toward the press member. A projection is provided on the press-member-side shim, the projection being fitted into the depression in order to restrict relative movement between the pad-side shim and the press-member-side shim along a pressing surface.

### BACKGROUND OF THE INVENTION

1. Field of the Invention

The present invention relates to a disc brake, and more particularly to a disc brake in which a layered shim for preventing generation of squeal during braking (hereinafter referred to as an “anti-squeal layered shim”) is attached to a backing plate of a pad so as to be interposed between the backing plate of the pad and a press member for pressing the pad toward a disc rotor.

2. Description of the Related Art

A disc brake of the above-mentioned type is disclosed in, for example, Japanese Patent Application Laid-Open (kokai) No. 6-129451. In such a disc brake, a press member presses a pad against a disc rotor via a layered shim in order to generate braking force. The layered shim employed in the disc brake disclosed in the above-mentioned publication consists of a first shim (a press-member-side shim) to be attached to the backing plate of the pad, and a second shim (a pad-side shim) which has a slit for holding lubricant and which is to be interposed between the backing plate and the first shim. In some layered shims, a rubber coated shim is employed as the pad-side shim, and/or the pad-side shim and the press-member-side shim are joined and fixed together by means of adhesive.

In the above-described conventional disc brake, squeal generated during braking is reduced through absorption of vibration and stabilization of surface pressure distribution, which are achieved by the layered shim disposed between the backing plate of the pad and the press member. However, in the conventional disc brake, the pad may move in the direction of rotation of the disc rotor during braking, whereby relative movement may occur between the pad-side shim and the press-member-side shim of the layered shim. In such a case, the absorption of vibration and the stabilization of surface pressure distribution, which are achieved by the layered shim, are impaired, possibly resulting in failure of the layered shim to sufficiently attain the squeal prevention effect.

### SUMMARY OF THE INVENTION

In view of the foregoing, an object of the present invention is to provide a disc brake in which joint between the pad-side shim and the press-member-side shim of a layered shim can be reliably maintained, whereby absorption of vibration and stabilization of surface pressure distribution, which are achieved by the layered shim, can be achieved for a long period of time without any impairment, so that the layered shim can consistently attain the squeal prevention effect over a long period of time.

In order to achieve the above object, the present invention provides a disc brake comprising a disc rotor, a pad having a backing plate, a press member for pressing the pad toward the disc rotor, and an anti-squeal layered shim attached to the backing plate and disposed between the press member and the backing plate of the pad. The layered shim includes a pad-side shim and a press-member-side shim. A depression is provided on a surface of the pad-side shim, the surface facing toward the press member. A projection is provided on the press-member-side shim, the projection being fitted into the depression in order to restrict relative movement between the pad-side shim and the press-member-side shim along a pressing surface.

By virtue of the above-described configuration, even when relative movement is about to occur between the pad-side shim and the press-member-side shim of the layered shim upon movement of the pad in the rotational direction of the disc rotor during braking, such relative movement is prevented by means of fitting engagement between the above-described depression and projection. Therefore, the joint between the pad-side shim and the press-member-side shim of the layered shim is reliably maintained, whereby absorption of vibration and stabilization of surface pressure distribution, which are achieved by the layered shim, can be achieved over a long period of time without any impairment, and thus the layered shim can consistently attain the squeal prevention effect over a long period of time.

The projection may be formed through formation of a depression on a surface of the press-member-side shim, the surface facing toward the press member, and the depression may be provided in such a manner that at least a portion of the depression overlaps a pressing surface of the press member. In this case, the depression formed on the surface of the press-member-side shim facing toward the press member can be used as surface pressure adjustment means (means for reducing surface pressure).

Further, the pad-side shim and the press-member-side shim may be joined and fixed together by means of adhesive. In this case, the function of the adhesive, which joins and fixes the pad-side shim and the press-member-side shim together, is maintained over a long period of time, and the layered shim can consistently attain the squeal prevention effect over a long period of time.

### BRIEF DESCRIPTION OF THE DRAWINGS

Various other objects, features and many of the attendant advantages of the present invention will be readily appreciated as the same becomes better understood by reference to the following detailed description of the preferred embodiments when considered in connection with the accompanying drawings, in which:

FIG. 1 is a vertical cross-sectional view of a disc brake according to one embodiment of the present invention;

FIG. 2 is a front view of a layered shim shown in FIG. 1, as viewed from the pad side;

FIG. 3 is an enlarged cross-sectional view taken along line A-A of FIG. 2;

FIG. 4 is a front view corresponding to FIG. 2 and showing another embodiment of the present invention;

FIG. 5 is an enlarged cross-sectional view taken along line B-B of FIG. 4; and

FIG. 6 is a front view corresponding to FIG. 2 and showing still another embodiment of the present invention.

### DESCRIPTION OF THE PREFERRED EMBODIMENTS

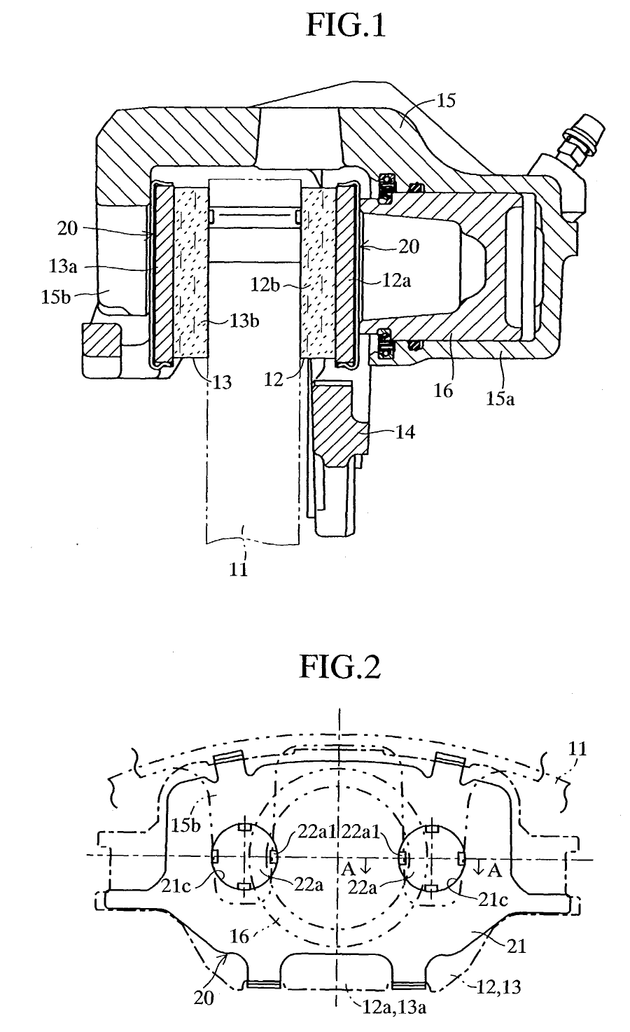

Embodiments of the present invention will now be described with reference to the drawings. FIGS. 1 to 3 show a disc brake according to an embodiment of the present invention. In this disc brake, an inner pad 12 and an outer pad 13, which press-hold and brake a disc rotor 11, are mounted to a mounting 14 so as to be movable over a predetermined distance in the direction of the rotor axis (the left-right direction in FIG. 1) and to be slightly movable in the circumferential direction of the rotor (in the rotational direction, more precisely, the tangential direction, of the disc rotor 11). Further, a movable caliper 15 is mounted to the mounting 14 to be movable in the direction of the rotor axis.

The inner pad 12 includes a backing plate 12a and a lining 12b. The inner pad 12 is pressed and moved toward the disc rotor 11 by means of a piston 16, which is accommodated in a cylinder portion 15a of the movable caliper 15 to be movable in the direction of the rotor axis. Further, an anti-squeal layered shim 20 is attached to the backing plate 12a of the inner pad 12, so that the anti-squeal layered shim 20 is interposed between the backing plate 12a and the piston 16.

Meanwhile, the outer pad 13 includes a backing plate 13a and a lining 13b. The outer pad 13 is pressed and moved toward the disc rotor 11 by means of a reaction arm portion 15b of the movable caliper 15, which portion is formed to overhang the pads 12 and 13. Further, an anti-squeal layered shim 20 is attached to the backing plate 13a of the outer pad 13, so that the anti-squeal layered shim 20 is interposed between the backing plate 13a and the reaction arm portion 15b.

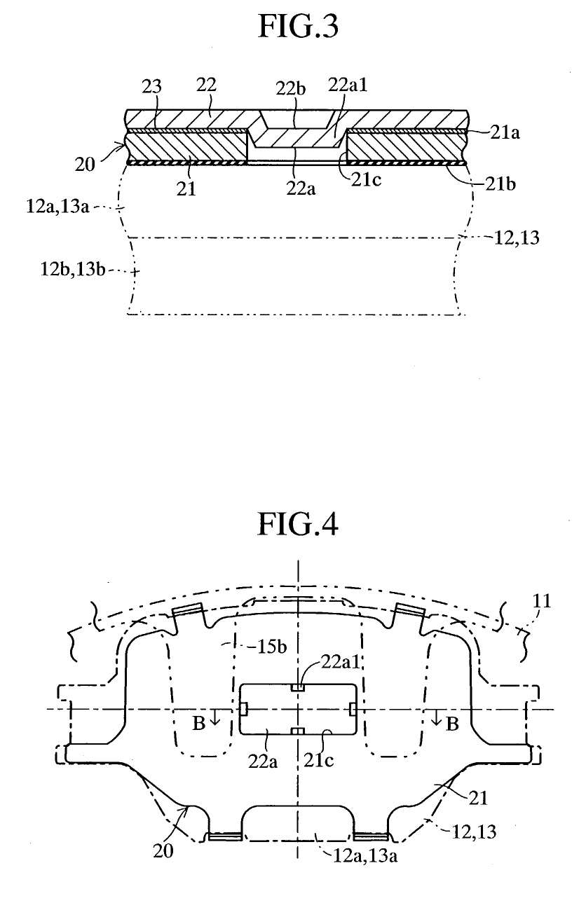

As shown in FIGS. 2 and 3, each of the layered shims 20 is composed of a rubber-coated shim 21 attached to the back surface (rear surface) of the backing plate 12a or 13a of the corresponding pad 12 or 13, and an SUS shim 22 which is joined and fixed to the back surface of the rubber-coated shim 21 by use of adhesive 23. The rubber-coated shim 21 is a layered plate consisting of a base plate 21a made of mild steel (SPCC), and a heat-resistant rubber layer (a layer of NBR rubber) 21b laminated on a surface of the base plate 21a. The SUS shim 22 is a plate made of stainless steel (SUS).

The disc brake having the above-described configuration operates as follows. During braking, pressurized oil is supplied to the cylinder portion 15a of the movable caliper 15, whereby the pressurized oil causes the piston 16 to press the inner pad 12 toward the disc rotor 11 via the layered shim 20, with generation of a reaction force which causes the reaction arm portion 15b of the movable caliper 15 to press the outer pad 13 toward the disc rotor 11 via the layered shim 20. Therefore, the inner pad 12 and the outer pad 13 are pressed against the disc rotor 11, so that the inner pad 12 and the outer pad 13 press-hold the disc rotor 11 to thereby generate a braking force.

In the disc brake of the present embodiment, as shown in FIGS. 2 and 3, two circular through-holes 21c are formed in the rubber coated shim 21 of the layered shim 20; and two circular projections 22a are formed on the SUS shim 22 of the layered shim 20. Each of the circular projections 22a has four inclined connecting portions 22a1, which are located at the upper, lower, left, and right sides, respectively, in FIG. 2, and is fitted into the corresponding circular through-hole 21c (a depression provided on the rubber coated shim 21). This configuration restricts relative movement between the rubber coated shim 21 and the SUS shim 22 of the layered shim 20 along a pressing surface (the back surface of the SUS 22, with which the piston 16 or the reaction arm portion 15b of the movable caliper 15 comes into contact).

Therefore, even when relative movement is about to occur between the rubber coated shim 21 and the SUS shim 22 of the layered shim 20 along the pressing surface upon movement of the pad 12 or 13 in the rotational direction of the disc rotor 11 during braking, such relative movement is prevented by means of fitting engagement between the two circular through-holes 21c and the two circular projections 22a. Therefore, the joint between the rubber coated shim 21 and the SUS shim 22 of the layered shim 20 is reliably maintained, whereby absorption of vibration and stabilization of surface pressure distribution, which are achieved by the layered shim 20, can be achieved over a long period of time without any impairment, and thus the layered shim 20 can consistently attain the squeal prevention effect over a long period of time.

Further, in the disc brake of the present embodiment, as shown in FIG. 3, each of the circular projections 22a is formed through formation of a depression 22b on the back surface of the SUS shim 22 (on the side toward the piston 16 or the reaction arm portion 15b; i.e., on the side toward the press member); and, as indicated by an imaginary line in FIG. 2, the depression 22b is provided in such a manner that at least a portion of the depression 22b overlaps the pressing surface of the reaction arm portion 15b (or the piston 16). Therefore, the depression 22b formed on the back surface of the SUS shim 22 can be used as surface pressure adjustment means (means for reducing surface pressure).

Further, in the disc brake of the present embodiment, since the above-described configuration (fitting engagement between the two circular through-holes 21c and the two circular projections 22a) restricts relative movement between the rubber coated shim 21 and the SUS shim 22 of the layered shim 20 along the pressing surface, the function of the adhesive 23, which joins and fixes the rubber coated shim 21 and the SUS shim 22 together, is maintained over a long period of time, and the layered shim 20 can consistently attain the squeal prevention effect over a long period of time.

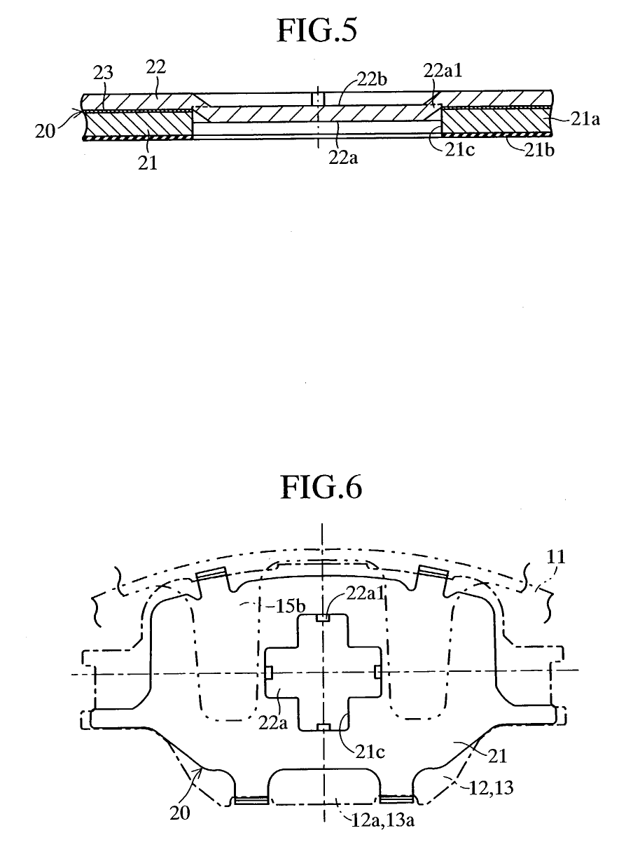

In the above-described embodiment, relative movement between the rubber coated shim 21 and the SUS shim 22 of the layered shim 20 along the pressing surface is suppressed by means of fitting engagement between the two circular through-holes 21c and the two circular projections 22a. However, the relative movement can be suppressed by means of fitting engagement between a single rectangular (non-circular) through-hole 21c and a single rectangular projection 22a as shown in FIGS. 4 and 5, or fitting engagement between a single cruciform (non-circular shape) through-hole 21c and a single cruciform projection 22a as shown in FIG. 6.

In the embodiments shown in FIGS. 4 and 6, the projection 22a has four inclined connecting portions 22a1, which are located at the upper, lower, left, and right sides, respectively, and is fitted into the through-hole 21c (a depression provided on the rubber coated shim 21). This configuration restricts relative movement between the rubber coated shim 21 and the SUS shim 22 of the layered shim 20 along the pressing surface. Further, as indicated by broken lines in FIG. 5, the upper, lower, left, and right cut end surfaces of the projections 22a restrict such relative movement.

In the above-described embodiments, a through-hole 21c of a circular, rectangular, or cruciform shape is employed as a depression provided on the rubber coated shim 21 (a depression into which the projection 22a of the SUS shim 22 is fitted). However, a bottomed hole of a circular, rectangular, or cruciform shape which is open toward the SUS shim 22 may be employed as a depression provided on the rubber coated shim 21.

In the above-described embodiments, the present invention is applied to a disc brake which employs the above-described layered shim 20 in which the rubber coated shim 21 and the SUS shim 22 are joined and fixed together by use of the adhesive 23. However, the present invention can be applied to a disc brake which employs a layered shim in which a rubber coated shim and an SUS shim are merely brought into contact with each other, with or without a modification.

Obviously, numerous modifications and variations of the present invention are possible in light of the above teachings. It is therefore to be understood that within the scope of the appended claims, the present invention may be practiced otherwise than as specifically described herein.

What is claimed is:

1. A disc brake comprising:
a disc rotor;
a pad having a backing plate;
a press member for pressing the pad toward the disc rotor; and
an anti-squeal layered shim attached to the backing plate and disposed between the press member and the backing plate of the pad, wherein
the layered shim includes a pad-side shim and a press-member-side shim;
a depression is provided on a surface of the pad-side shim, the surface facing toward the press member; and
a projection is provided on the press-member-side shim, the projection being fitted into the depression in order to restrict relative movement between the pad-side shim and the press-member-side shim along a pressing surface.

2. A disc brake according to claim 1, wherein the projection is formed through formation of a depression on a surface of the press-member-side shim, the surface facing toward the press member, and the depression of the press-member-side shim is provided in such a manner that at least a portion of the depression overlaps a pressing surface of the press member.

3. A disc brake according to claim 1, wherein the pad-side shim and the press-member-side shim are joined and fixed together by means of adhesive.

4. A disc brake according to claim 2, wherein the pad-side shim and the press-member-side shim are joined and fixed together by means of adhesive.
